(19) United States
(12) Patent Application Publication
(10) Pub. No.: US 2006/0176720 A1
(43) Pub. Date: Aug. 10, 2006

(54) Rotating rectifier with strap and diode assembly

(75) Inventors: Glenn C. Lemmers JR., Loves Park, IL (US); Mark A. Osborn, Cherry Valley, IL (US); Douglas J. Turner, Rockford, IL (US); Gregory C. Christiansen, Loves Park, IL (US)

Correspondence Address: CARLSON, GASKEY & OLDS, P.C., 400 WEST MAPLE ROAD, SUITE 350, BIRMINGHAM, MI, 48009, US

(73) Assignee: Hamilton Sundstrand Corporation

(21) Appl. No.: 11/052,488

(22) Filed: Feb. 4, 2005

(51) Int. Cl. H02M 1/00

(52) U.S. Cl. 363/145; 310/68 B

(57) ABSTRACT

The present invention is a rectifier assembly having three phase straps with two diodes mounted to each phase strap. The rectifier assembly also includes a first support and a second support, which are received within a housing. The phase straps are assembled together with the first and second supports. The diodes are each connected to the phase straps so that when assembled the diodes are each perpendicular to an axis at the center of the electrically insulated housing. During operation the first and second supports rotate about the axis.

### BACKGROUND OF THE INVENTION

The present invention is a rectifier configuration that can be used with a number of applications, in particular brushless generators.

Rectifier assemblies have been incorporated into rotors for electromagnetic machines in order to eliminate the need for conduction brushes. However, in this configuration, the rectifier assemblies are subjected to harsh environments. Environmental factors such as mechanical loads, hydraulic fluid flow, and temperature extremes, for example, can adversely affect efficient operation of the rectifier assemblies. Further, this exposed configuration of the rectifier assemblies increases the potential for damage to the rectifier assemblies during assembly and handling of the rotor.

Also, as a result of attachment to the rotor, the rectifier assemblies are subject to high centrifugal forces during operation. The high centrifugal forces create problems within the rectifier assemblies by placing diodes within the rectifier assemblies under sheer, or tensile stress during operation. In addition, high operating speeds can also subject the rectifier assemblies to excessive heat. The excessive heat must be dissipated from the rectifier assembly, especially away from the diodes in order to maintain efficient operation of the rectifier assembly.

The harsh loading and heat conditions on the rectifier assemblies also cause excessive wear on the assemblies, in particular the diodes. Additionally, these harsh loading and heat conditions can adversely affect electrical contacts between internal components of the rectifier assembly. If electrical contacts are not maintained, the rectifier assembly will not operate effectively. The rectifier assemblies must be serviced to replace worn and failed diodes. Because of the difficulty of service and assembly, the entire rectifier assembly must often be replaced when a diode fails, which is expensive.

Thus, a rectifier assembly that can withstand high operating forces and heat while operating in a harsh environment is needed.

### SUMMARY OF THE INVENTION

A rectifier assembly of the present invention has three phase straps. Two diodes are mounted to each phase strap. The rectifier assembly also includes a first support and a second support that each have an inner peripheral surface with three inwardly facing diode surfaces. The phase straps are assembled together with the first and second supports. A first phase strap has first and second diodes, a second phase strap has third and fourth diodes, and a third phase strap has fifth and sixth diodes. Once assembled, the first, third, and fifth diodes are associated with the three inwardly facing diode surfaces of the first support, and the second, fourth, and sixth diode are associated with the three inwardly facing diode surfaces of the second support. The diodes are all mounted such that compressive forces act on the diodes after mounting and during operation of the rectifier assembly.

An electrically insulated housing has a generally circular cross-section. The first and second supports are received within the electrically insulated housing. The diodes are each connected to the phase straps so that the diodes are each perpendicular to an axis at the center of the electrically insulated housing when assembled. During operation, the first and second supports rotate about the axis. Forces acting upon the phase straps press the phase straps outward from the axis. Outward pressure of the phase straps puts compressive pressure on the diodes as they are pressed toward the first and second supports. By mounting the diodes in this manner, the centrifugal loads help maintain electrical contact during operation. Additionally, the phase straps are slightly flexible to absorb some of the forces during operation of the rectifier assembly.

The first support and the second support also act as heat sinks to remove heat that is generated by the diodes during operation. In addition, a hollow shaft is located in the center of the electrically insulated housing along the axis. Openings allow oil spray to exit the hollow shaft and cool the diodes in a manner which minimizes turbulence and frictional losses as the cooling medium flows through the diode assembly.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 illustrates a general perspective view of a rectifier assembly of one embodiment of the present invention; and

FIG. 2 is an end view of a rectifier assembly of one embodiment of the present invention.

### DETAILED DESCRIPTION OF THE PREFERRED EMBODIMENT

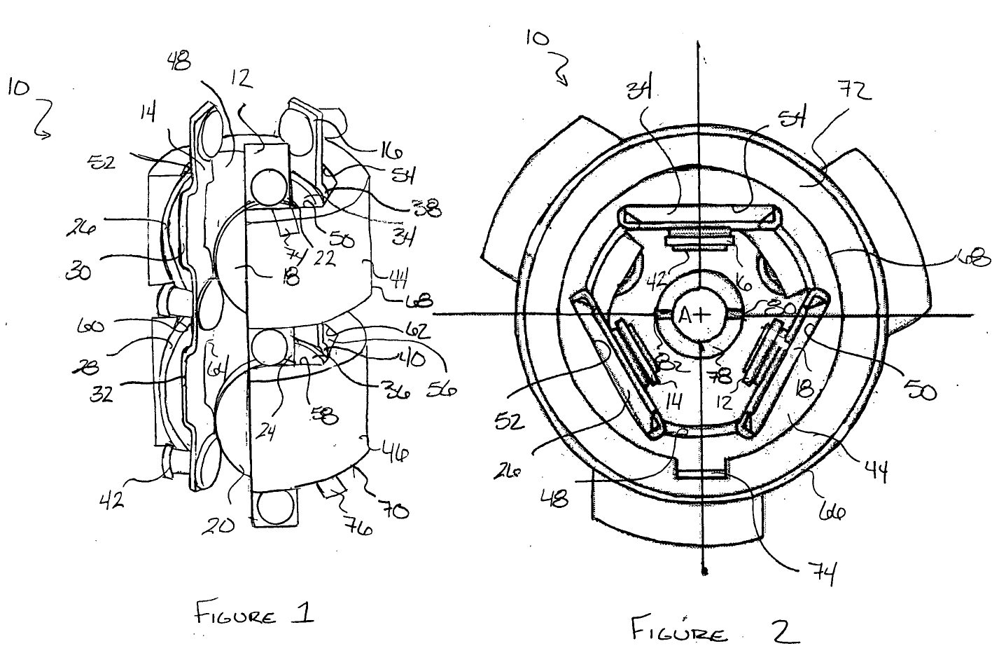

FIG. 1 illustrates a general view of a rectifier assembly 10 having first, second, and third phase straps 12, 14, 16. A first diode 18 and second diode 20 are mounted to the first phase strap 12 at a first mounting location 22 and a second mounting location 24, respectively. The second phase strap 14 has a third diode 26 and a fourth diode 28 mounted at a third mounting location 30 and a fourth mounting location 32, respectively. The third phase strap 16 has a fifth diode 34 and a sixth diode 36 mounted at a fifth mounting location 38 and a sixth mounting location 40, respectively. The first through sixth diodes 18, 20, 26, 28, 34, 36 are mounted to the phase straps 12, 14, 16 by means of fasteners 42 or other attachment mechanisms. The fasteners 42 shown are screws and nuts. The fasteners 42 may take many forms and those skilled in the art would know the appropriate type and number of fasteners required for an application.

The rectifier assembly 10 also includes a first support 44 and a second support 46. In this embodiment, the first support 44 and the second support 46 each have a ring shape. The first support 44 has an inner peripheral surface 48 with three inwardly facing diode surfaces 50, 52, 54. The second support 46 also has an inner peripheral surface 56 with three inwardly facing diode surfaces 58, 60, 62. It is required that the polarity for the diodes be reversed between the first and second supports.

The first, second, and third phase straps 12, 14, 16 are assembled together with the first support 44 and the second support 46. Once assembled, the first diode 18, the third diode 26, and the fifth diode 34 are associated with the three inwardly facing diode surfaces 50, 52, 54 of the first support 44. The second diode 20, the fourth diode 28, and the sixth diode 36 are associated with the three inwardly facing diode surfaces 58, 60, 62 of the second support 46.

The first through sixth diodes 18, 20, 26, 28, 34, 36 are all mounted such that compressive forces act on the diodes subsequent to mounting. The compressive forces acting on the first through sixth diodes 18, 20, 26, 28, 34, 36 increase during operation of the rectifier assembly 10, as described below. The fasteners 42 act as a spacer between the first support 44 and the second support 46 to keep the first support 44 and the second support 46 electrically isolated from one another. A stress relief contour 64 on each of the three phase straps 12, 14, 16 reduces stress on the phase straps 12, 14, 16 during operation of the rectifier assembly 10.

Referring to FIG. 2, the rectifier assembly 10 includes an electrically insulated housing 66 having a generally circular cross-section defining an axis A that runs axially down a center of the electrically insulated housing 66. The first support 44 and the second support 46 are received within the electrically insulated housing 66. A first outwardly facing surface 68 on the first support 44 and a second outwardly facing surface 70 (FIG. 1) on the second support 46 are both shaped to correspond to the shape of the electrically insulated housing 66. The axis A is generally parallel to the three phase straps 12, 14, 16. The first through sixth diodes 18, 20, 26, 28, 34, 36 are each connected to the phase straps 12, 14, 16 in the diode mounting locations 22, 24, 30, 32, 38, 40 so that the first though sixth diodes 18, 20, 26, 28, 34, 36 are each perpendicular to the axis A when assembled into the electrically insulated housing 66.

The axis A is located at the center of the first and second supports 44 and 46. During operation of the rectifier assembly 10, the first and second supports 44 and 46 rotate about the axis A. Forces acting upon the phase straps 12, 14, 16 press the phase straps 12, 14, 16 outward from the axis A. The first and second supports 44 and 46 are relatively rigid. Thus, the outward pressure of the phase straps 12, 14, 16 puts compressive pressure on the first through sixth diodes 18, 20, 26, 28, 34, 36 by pressing the first through sixth diodes 18, 20, 26, 28, 34, 36 against the rigid first support 44 and rigid second support 46.

Diodes are typically mounted parallel to the rotational axis, which introduces shear forces that act on the diodes during operation of the rectifier assembly. The shear forces increase the stress on the diodes, which causes the diodes to wear more quickly. Reducing operating speeds of the rectifier assemblies decreases operational stresses acting on the diodes, however, this is not a desirable solution. By mounting the first through sixth diodes 18, 20, 26, 28, 34, 36 perpendicular to the axis A, the shear stress is minimized during operation of the rectifier assembly 10.

Additionally, by mounting the first through sixth diodes 18, 20, 26, 28, 34, 36 to the phase straps 12, 14, 16, stress on the first through sixth diodes 18, 20, 26, 28, 34, 36 is further reduced because the phase straps 12, 14, 16 are slightly flexible to absorb some of the forces during operation of the rectifier assembly 10. Mounting the first through sixth diodes 18, 20, 26, 28, 34, 36 to the phase straps 12, 14, 16 also places the first through sixth diodes 18, 20, 26, 28, 34, 36 closer to the axis A and the center of rotation, further reducing centrifugal stress on the diodes. As a result, higher operating speeds of the rectifier assembly 10 can be achieved.

The phase straps 12, 14, 16 are shaped such that they each extend outwardly from a first end 72 (FIG. 2) of the electrically insulated housing 66. In addition, the first support 44 has a positive output terminal 74 and the second support 46 has a negative output terminal 76. The positive output terminal 74 extends from the first support 44 to the first end 72 of the electrically insulated housing 66. The negative output terminal 76 may extend to the first end 72 of the electrically insulated housing 66, or to an opposing end of the electrically insulated housing 66 depending on the application for which the rectifier assembly 10 is intended. Those skilled in the art would know the proper arrangement for the output terminals 74, 76.

The first support 44 and the second support 46 act as heat sinks to remove heat that is generated during operation from the first through sixth diodes 18, 20, 26, 28, 34 and 36. The first outwardly facing surface 68 and second outwardly facing surface 70 each may have various surface textures or shapes to assist in removing heat from the first though sixth diodes 18, 20, 26, 28, 34, 36. In addition a hollow shaft 78 is located in the center of the electrically insulated housing 66 along the axis A. Two openings 80 and 82 allow oil spray to exit the hollow shaft 78 and cool the first through sixth diodes 18, 20, 26, 28, 34, 36. This allows the rectifier assembly 10 to operate at higher temperatures.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A rectifier assembly comprising:
a plurality of straps wherein each strap includes first and second diode mounting portions axially spaced apart from each other along said strap; and
a plurality of diodes wherein one diode is mounted to each of said first and second diode mounting portions for each of said straps.

2. The rectifier assembly of claim 1, wherein said plurality of straps includes a first strap, a second strap, and a third strap.

3. The rectifier assembly of claim 1, wherein diodes mounted to said first diode mounting portions on each strap are connected to a positive output terminal ring, and diodes mounted to said second diode mounting portions on each strap are connected to a negative output terminal ring.

4. The rectifier assembly of claim 3, wherein said positive output terminal ring and said negative output terminal ring are received within an electrically insulated housing.

5. The rectifier assembly of claim 4, wherein said plurality of straps rotate relative to said electrically insulated housing about an axis defined by said positive and negative output terminal rings.

6. The rectifier assembly of claim 5, wherein said diodes are mounted to said plurality of straps such that said diodes are perpendicular to said axis.

7. The rectifier assembly of claim 1, wherein said diodes are mounted in compression against said first and second diode mounting portions.

8. The rectifier assembly of claim 1, wherein each strap is a phase conductor having an AC phase lead located at one end.

9. A rectifier assembly comprising:
a first strap including first and second diodes axially spaced apart from each other;
a second strap including third and fourth diodes axially spaced apart from each other;
a third strap including fifth and sixth diodes axially spaced apart from each other;
a positive output terminal ring having an outer peripheral surface and an inner peripheral surface facing said first, second, and third straps wherein said first diode, said third diode, and said fifth diode are mounted to said inner peripheral surface of said positive output terminal ring; and
a negative output terminal ring, having an outer peripheral surface and an inner peripheral surface facing said first, second, and third straps wherein said second diode, said forth diode, and said sixth diode are mounted to said inner peripheral surface of said negative output terminal ring.

10. The rectifier assembly of claim 9, wherein said first strap, said second strap, and said third strap are phase conductors each having an AC phase lead located at one end.

11. The rectifier assembly system of claim 9, wherein said first, second, third, fourth, fifth, and sixth diodes are mounted in compression.

12. The rectifier assembly of claim 9, wherein said positive output terminal ring and said negative output terminal ring are received within an electrically insulated housing.

13. The rectifier assembly of claim 12, wherein a first output terminal bar is connected to said positive output terminal ring and extends to a first end of said electrically insulated housing, and a second output terminal bar is connected to said negative output terminal ring and extends to said first end of said housing, said second output terminal bar being electrically isolated from said positive output terminal ring and from said first output terminal bar.

14. The rectifier assembly of claim 12, wherein said first strap, said second strap and said third strap rotate relative to said electrically insulated housing about an axis defined by said positive and negative output terminal rings.

15. The rectifier assembly of claim 14, wherein said first, second, third, fourth, fifth, and sixth diodes are mounted to said straps such that said first, second, third, fourth, fifth, and sixth diodes are perpendicular to said axis.

16. The rectifier assembly of claim 9, wherein said first strap, said second strap and said third strap each have a stress relief loop located between axially aligned diodes.

17. A method of assembling a rectifier comprising:
a) providing a first strap with a first set of diode mounting locations;
b) providing a second strap with a second set of diode mounting locations;
c) providing a third strap with a third set of diode mounting locations;
d) mounting a diode in compression at each diode mounting location for the first, second and third straps;
e) connecting a positive output terminal ring to one diode of the first strap, one diode of the second strap, and one diode of the third strap; and
f) connecting a negative output terminal ring to another diode of the first strap, another diode of the second strap and another diode of the third strap.

18. The method of claim 17 further comprising;
g) inserting the positive output terminal ring and the negative output terminal ring within a housing.

19. The method of claim 18, wherein said step g) includes axially spacing the positive output terminal ring from the negative output terminal ring.
